(19) United States
(12) Patent Application Publication
(10) Pub. No.: US 2016/0211102 A1
(43) Pub. Date: Jul. 21, 2016

(54) REMOTE ACTUATOR MOUNTING BRACKET TO PREVENT INADVERTENT BREAKER OPERATION

(71) Applicant: MarTek Limited, Charleston, WV (US)

(72) Inventors: Charles Mark McClung, Elkview, WV (US); Russell Safreed, Saint Albans, WV (US)

(21) Appl. No.: 14/988,126

(22) Filed: Jan. 5, 2016

Related U.S. Application Data
(60) Provisional application No. 62/105,868, filed on Jan. 21, 2015.

(51) Int. Cl. H01H 71/50; H01H 69/00; H01H 71/02

(52) U.S. Cl. CPC H01H 71/50; H01H 71/0207; H01H 69/00

(57) ABSTRACT

A bracket that is attached to a circuit breaker, or circuit breaker enclosure, is designed to allow a remote actuator assembly to be temporarily installed on the breaker. The bracket is designed in such a manner that, once installed, it will allow a human operator to attach a remote actuator assembly to the mounting bracket and that the process of attaching the actuator will not inadvertently cause the breaker to be “opened” or “closed”.

### CROSS-REFERENCE TO RELATED APPLICATIONS

This application claims priority to copending U.S. Provisional Patent Application titled “REMOTE ACTUATOR MOUNTING BRACKET TO PREVENT INADVERTENT BREAKER OPERATION,” filed on Jan. 21, 2015 and assigned application No. 62/105,868, which is incorporated by reference herein in its entirety.

### FIELD OF THE INVENTION

The present disclosure generally relates to the operation of circuit breakers that have separate push buttons for closing and opening (tripping) the circuit breaker.

### BACKGROUND

In large power systems, a typical circuit breaker is operated by a human operator who physically pushes an “open” or “close” button located on or near the circuit breaker. When a human operator causes the circuit breaker to open or close by pressing the open or close buttons while being in close proximity of the circuit breaker, the operator is exposed to possible arc-blast energy if the circuit breaker should catastrophically fail during this activity. Recognizing the potential hazard of personal injury associated with the close proximity operation of electrical circuit breakers, it is advantageous for the human operator to utilize a temporarily installed actuator that allows remote operation of the circuit breaker. The remote actuator assembly may utilize motors, solenoids, or linear actuators that can be remotely commanded to operate breaker without the human operating being in close proximity.

Using a remote actuator assembly requires the additional step of temporarily attaching the remote actuator over the open and close buttons on the breaker. There is a hazard when the human operator is in the process of installing the remote actuator assembly in that the operator could inadvertently “bump” or press the open or close buttons and cause an unintended operation of the circuit breaker. This inadvertent operation would expose the human operator to potentially the same arc-blast energy in which the remote actuator assembly is intended to protect the human operator from. Additionally, inadvertent operation of the circuit breaker could be catastrophic to the equipment or facilities in which the circuit breaker is supplying electrical energy.

### SUMMARY

Included are apparatuses, systems, and methods for a mounting bracket for remote operation of a circuit breaker. One embodiment of a system, among others, includes a system for remote operation of a circuit breaker, the system comprising a mounting bracket affixed to a face of the circuit breaker, the mounting bracket comprising a slotted section comprising one or more mounting bracket slots; and a portable actuator assembly coupled to the mounting bracket comprising: a recessed groove extending from a first end to a second end of the portable actuator, the recessed groove being engaged with the slotted section of the mounting bracket; and one or more pins positioned substantially perpendicular to the recessed groove, individual pins of the one or more pins being positioned within a respective slot of the one or more mounting slots.

Another embodiment of an apparatus, among others, includes a mounting bracket for attaching a remote actuator assembly to a circuit breaker, the mounting bracket comprising a mounting section and a slotted section extending outwardly from and substantially perpendicular to the mounting section, the slotted section comprising at least one mounting slot sized to engage with at least one pin of the remote actuator assembly.

Another embodiment of a method, among others, includes a method, comprising attaching a mounting bracket to a face of a circuit breaker, engaging a pin of an actuator assembly with a slot of the mounting bracket, and adjusting a position of actuator assembly about the mounting bracket to align an actuator of the actuator assembly with a breaker button of the circuit breaker.

Other embodiments, systems, methods, features, and advantages of this disclosure will be or will become apparent to one with skill in the art upon examination of the following drawings and detailed description. It is intended that all such additional apparatuses, methods, features, and advantages be included within this description and be within the scope of the present disclosure.

### BRIEF DESCRIPTION OF DRAWINGS

Many aspects of the present disclosure can be better understood with reference to the following drawings. The components in the drawings are not necessarily to scale, emphasis instead being placed upon clearly illustrating the principles of the present disclosure. Like reference numerals designate corresponding parts throughout the several views.

FIG. 1 is an example of a drawing of the face of a typical circuit breaker showing the open and close pushbuttons.

FIG. 2 is an example of perspective view of the circuit breaker of FIG. 1 with a remote actuator assembly mounting bracket installed, according to various embodiments of the present disclosure.

FIG. 3 is an example of a perspective view of a typical remote actuator assembly with the linear actuators fully retracted.

FIG. 4 is an example of a perspective view of the typical remote actuator assembly of FIG. 3 with the linear actuator for the close button shown in the extended position.

FIG. 5 is an example of a perspective view of the typical remote actuator assembly of FIG. 3 with the linear actuator for the open button shown in the extended position.

FIG. 6 is an example of a bottom view of the typical remote actuator assembly of FIG. 3.

FIG. 7 is an example of a front view of the typical circuit breaker of FIG. 1 with the typical remote actuator assembly of FIG. 3 installed utilizing the mounting bracket of FIG. 2, according to various embodiments of the present disclosure.

FIG. 8 is an example of a section view of the remote actuator assembly and circuit breaker of FIG. 7 with the remote actuator assembly shown being engaged on the mounting bracket of FIG. 2 prior to being slid downward into the “ready to be used” position according to various embodiments of the present disclosure. FIG. 8 further illustrates that, due to dimensional features of the bracket and the actuator assembly, the linear actuators of the actuator assembly are not in a position that could inadvertently engage the open and/or close buttons of the circuit breaker.

FIG. 9 is an example of a section view of the remote actuator assembly and circuit breaker of FIG. 7 showing the remote actuator assembly engaged with the mounting bracket of FIG. 2 in the “ready to be used” position, according to various embodiments of the present disclosure.

FIG. 10 is an example of a section view of the remote actuator assembly and circuit breaker of FIG. 7 engaged with the mounting bracket of FIG. 2 showing the linear actuator in the extended position and pushing the breaker open button, according to various embodiments of the present disclosure.

FIG. 11 is an example of a section view of the remote actuator assembly and circuit breaker of FIG. 7 with the remote actuator assembly shown with a linear actuator extended while attempting to install the actuator incorrectly on the mounting bracket of FIG. 2, according to various embodiments of the present disclosure. FIG. 11 illustrates an example of mounting bracket preventing the extended linear actuator from engaging the breaker close button, thereby preventing an inadvertent operation of the circuit breaker.

FIG. 12 is an example of a section view of the remote actuator assembly and circuit breaker of FIG. 7 with the remote actuator assembly shown with a linear actuator in the extended position while attempting to install the actuator correctly on the mounting bracket of FIG. 2, according to various embodiments of the present disclosure. FIG. 12 illustrates that mounting bracket prevents the extended linear actuator from engaging with the circuit breaker close button, thereby preventing an inadvertent operation of the circuit breaker.

FIG. 13 is an example a perspective view of the typical remote actuator assembly of FIG. 3 with the linear actuators fully retracted and being positioned in alignment against the mounting bracket of FIG. 2, according to various embodiments of the present disclosure.

FIG. 14 is an example of a perspective view of the typical remote actuator assembly of FIG. 3 with the linear actuators fully retracted and positioned against the breaker face and above the open and close pushbuttons and being engaged with the mounding bracket of FIG. 2, according to various embodiments of the present disclosure.

FIG. 15 is an example of a perspective view of the typical remote actuator assembly of FIG. 3 with the linear actuators fully retracted and positioned against the breaker face and being engaged with the features of the mounting bracket of FIG. 2, according to various embodiments of the present disclosure.

FIG. 16 is an example of a perspective view of the typical remote actuator assembly of FIG. 3 with the linear actuators fully retracted and positioned against the breaker face and positioned over the open and close buttons and being fully engaged with the mounting bracket of FIG. 2, according to various embodiments of the present disclosure.

FIG. 17 is an example of a perspective view of the typical remote actuator assembly of FIG. 3 with one of the linear actuators extended while the human operator is attempting to attach to the mounting bracket of FIG. 2, according to various embodiments of the present disclosure.

### DETAILED DESCRIPTION

In the following discussion, a general description of apparatuses and methods according to various embodiments of the present disclosure is provided, followed by a discussion of the operation of the same. Embodiments of the present disclosure relate to a portable remote actuator assembly mounting bracket capable of holding the remote actuator assembly in place over a circuit breaker open and close buttons. The mounting bracket of the present disclosure can minimize the potential hazard of personal injury, equipment damage, or loss of production with inadvertent operation that could take place while attaching the remote actuator assembly. In the following discussion, a general description of the system and its components is provided, followed by a discussion of the operation of the same.

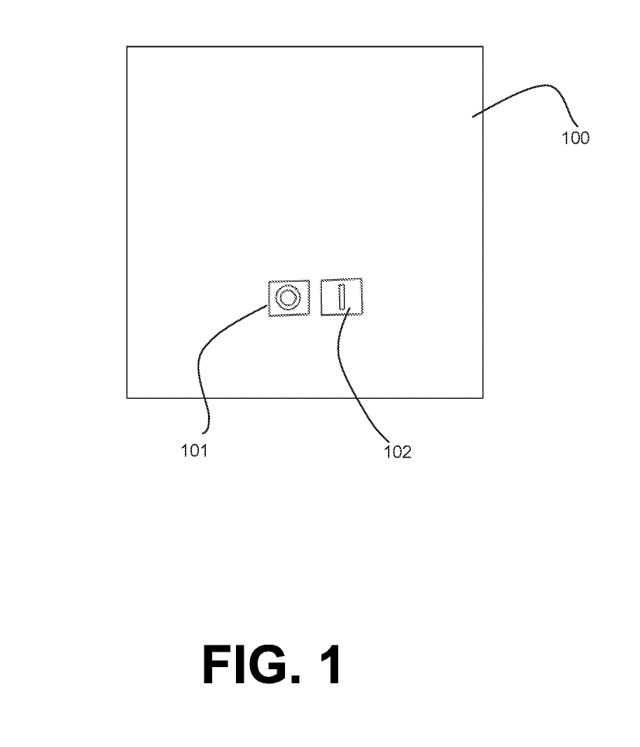

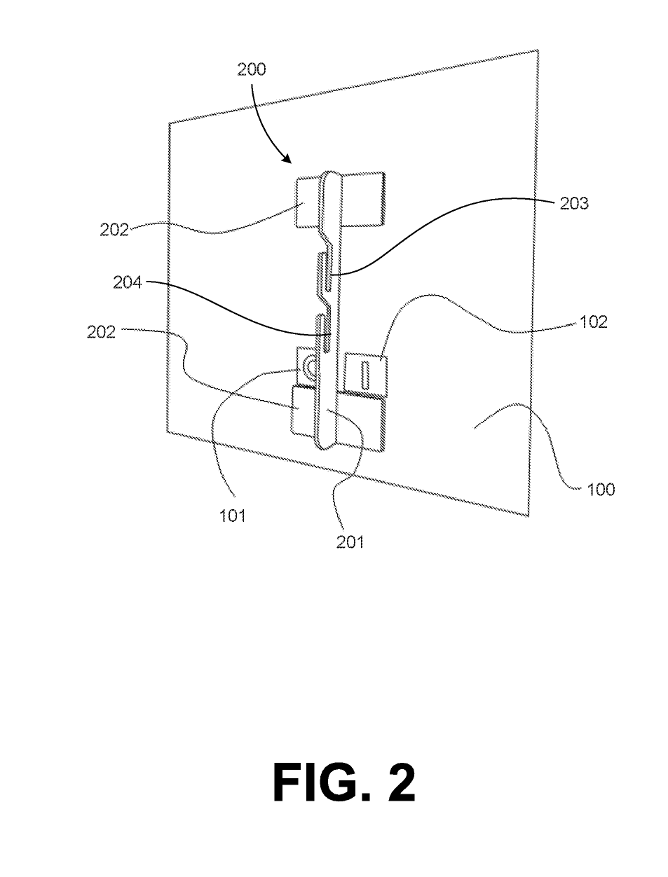

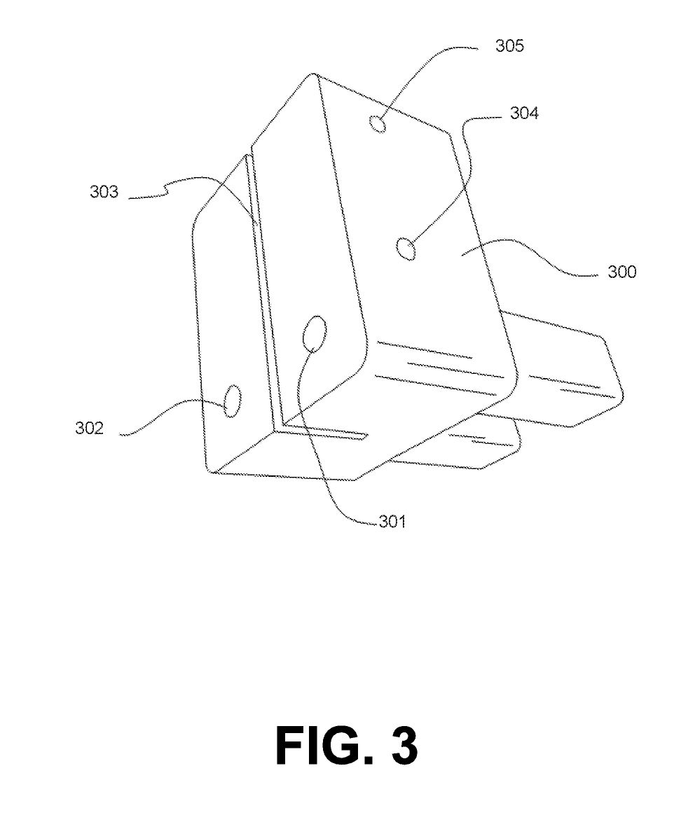

With reference to FIG. 1, shown is an example of a front view of a typical circuit breaker 100 according to various embodiments. The circuit breaker 100 includes an open button 101 and a close button 102. While the open button 101 and the close button 102 are shown in a horizontal arrangement in FIG. 1 with the open button 101 to the left of the close button 102, the arrangement of the open button 101 and close button 102 is not limited to this arrangement. For example, in some embodiments, the open button 101 and close button 102 can be in a vertical arrangement, the open button 101 can be positioned to the right of the close button 102, the open button 101 may be above the close button 102, and/or the open button can be positioned above close button 102. The front of the circuit breaker can include other embodiments not shown on FIG. 1 that are not relevant to the design or operation of the mounting bracket 200 (FIG. 2) and remote actuator assembly 300 (see FIG. 3).

With reference to FIG. 2, shown is an example of a perspective view of the typical circuit breaker 100 with the remote actuator assembly mounting bracket 200 permanently installed on the face of the circuit breaker 100. The mounting bracket 200 comprises a slotted section 201 extending outwardly from and substantially perpendicular to one or more mounting sections 202. In some embodiments, the slotted section 201 and the one or more mounting sections 202 are separate pieces coupled together (e.g. soldering, welding, brazing, brackets, screws, etc.) to form the mounting bracket 200. For example, the slotted section 201 can be coupled substantially perpendicular to the one or more mounting sections 202 to form an I-shaped arrangement.

In other embodiments, the mounting bracket 200 is a one-piece bracket formed to comprise the slotted section 201 and one or more mounting sections 202. For example, the mounting bracket 200 may comprise a one-piece unitary material (e.g., metal, plastic, etc.) that is formed (e.g., bent, molded, etc.) such that the slotted section 201 extends outwardly and substantially perpendicular to the one or more mounting section 202.

The slotted section 201 comprises one or more mounting bracket slots 203 and 204 for engaging with pins 304, 305 (FIG. 3) of a remote actuator assembly 300 (FIG. 3). It should be noted that the slotted section 201 of the mounting bracket 200 extends outwardly from the one or more mounting sections 202 at a distance that is greater than the length of extended linear actuators 301, 302 (FIG. 3) of the remote actuator assembly 300. The distance being greater than the length of the extended linear actuators 301, 302 prevents inadvertent engagement of the extended linear actuator 301, 302 with the open button 101 and/or close button 102 during placement of the remote actuator assembly 300 onto a mounting bracket 200 that has been mounted to the circuit breaker 100.

The mounting bracket 200 can be installed on the face of the circuit breaker 100 (FIG. 1) via the one or more mounting sections 201 by various methods that include glue, epoxy, riveting, screws, bolts, double-sided tape, and/or any other type of suitable adhesive and/or fastening device. The mounting bracket 200 is installed onto the circuit breaker 100 such that an entry position of the one or more mounting bracket slots 203, 204 for the pins 304, 305 is not aligned with the open button 101 (FIG. 1) and/or close button 102 (FIG. 1) of the circuit breaker 100. This prevents inadvertent engagement of an extended linear actuator 301, 302 (FIG. 3) with the open button 101 and/or close button 102 of the circuit breaker 100.

With reference to FIG. 3, shown is an example of a perspective view of a typical remote actuator assembly 300 with the linear actuators 301 and 302 fully retracted, according to various embodiments of the present disclosure. The remote actuator assembly 300 comprises linear actuators 301 and 302, pins 304 and 305, (or an equivalent), and a mounting bracket grove 303. The mounting bracket grove 303 extends vertically long recessed within the front face of the remote actuator assembly 300. The pins 304 and 305 pass through the actuator assembly 300 such that they cross through the mounting bracket groove 303. Although the remote actuator assembly 300 of FIG. 3 comprises two pins 304 and 305, other embodiments of the remote actuator assembly 300 may comprise less or more pins. The number of slots on the mounting bracket 200 for a remote actuator assembly 300 corresponds to the number of pins within the remote actuator assembly 300 such that each of the pins of the remote actuator assembly 300 can engage with a respective pin of the remote actuator assembly 300.

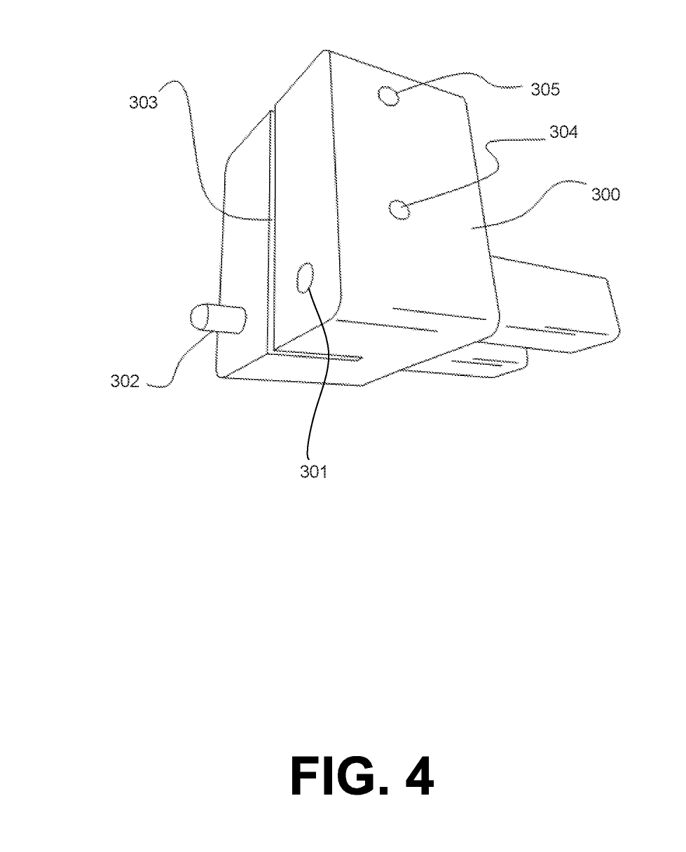

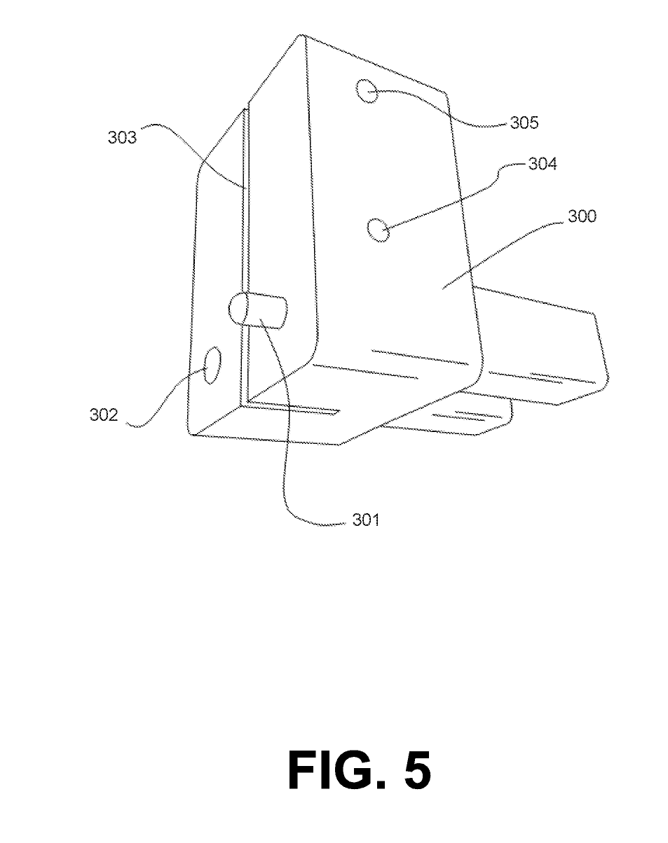

With reference to FIGS. 4 and 5, shown are examples of a perspective view of the remote actuator assembly 300 of FIG. 3 illustrating the linear actuators 301 and 302 in extended positions. Specifically, in FIG. 4, linear actuator 302 is shown in the extended position and linear actuator 301 is fully retracted. In contrast, FIG. 5 illustrates linear actuator 301 in the extended position and linear actuator 302 being fully retracted.

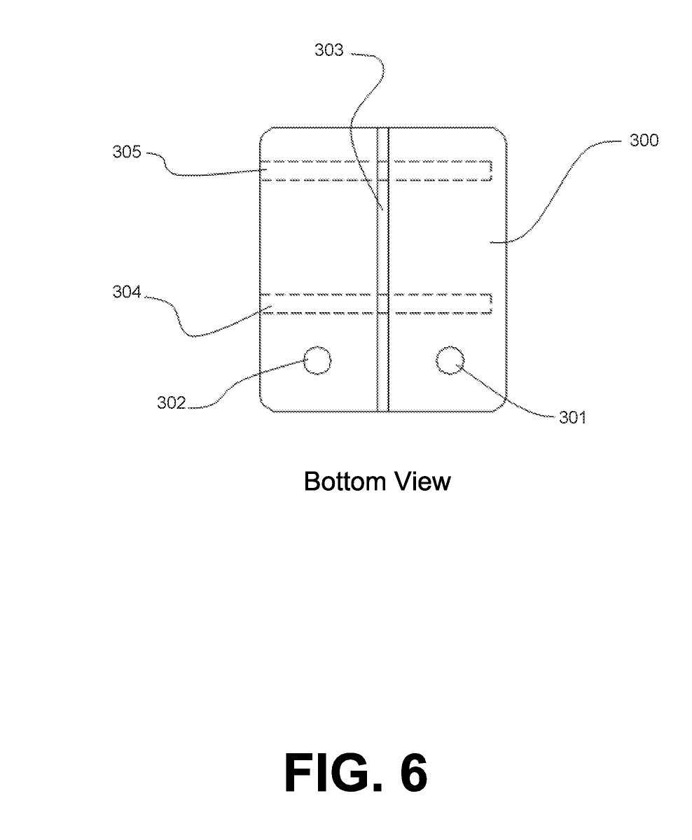

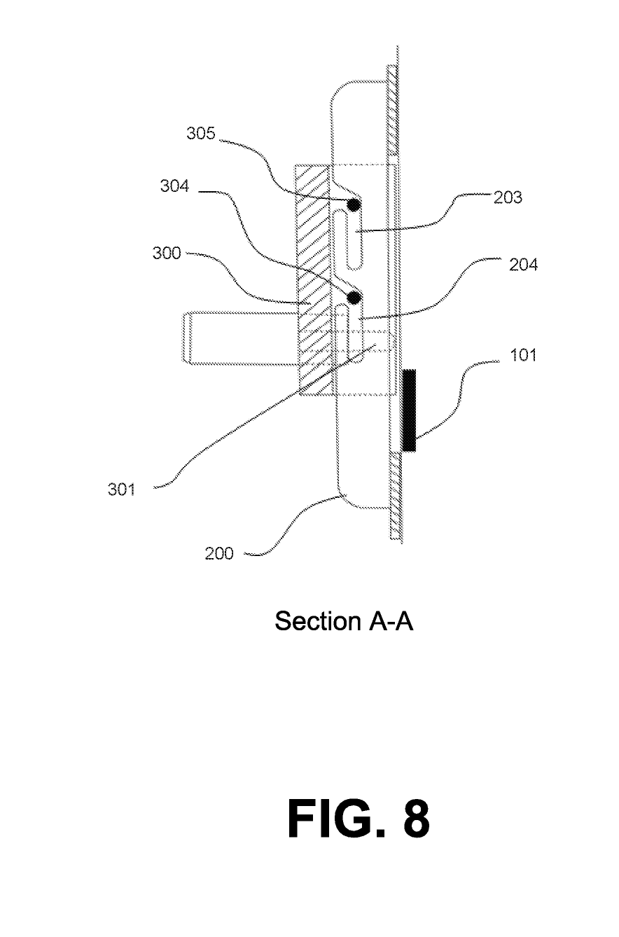

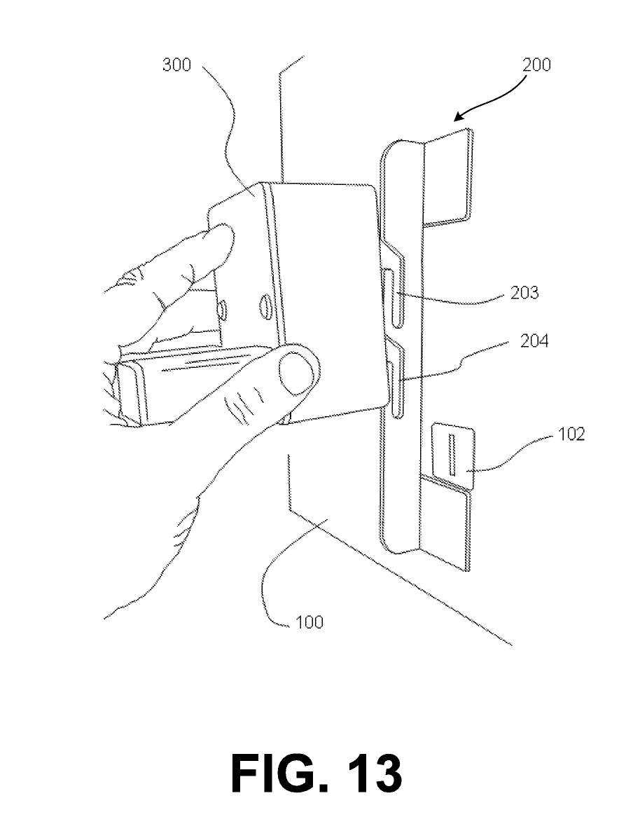

With reference to FIG. 6, shown is an example of the bottom view of the remote actuator assembly 300 of FIG. 3 according to various embodiments of the present disclosure. Portions of the pins 304 and 305 can be viewed via the recessed area formed by the mounting bracket groove 303. The mounting bracket groove 303 engages the mounting bracket 200 (FIG. 13) and the pins 304 and 305 engage the mounting bracket slots (FIG. 8).

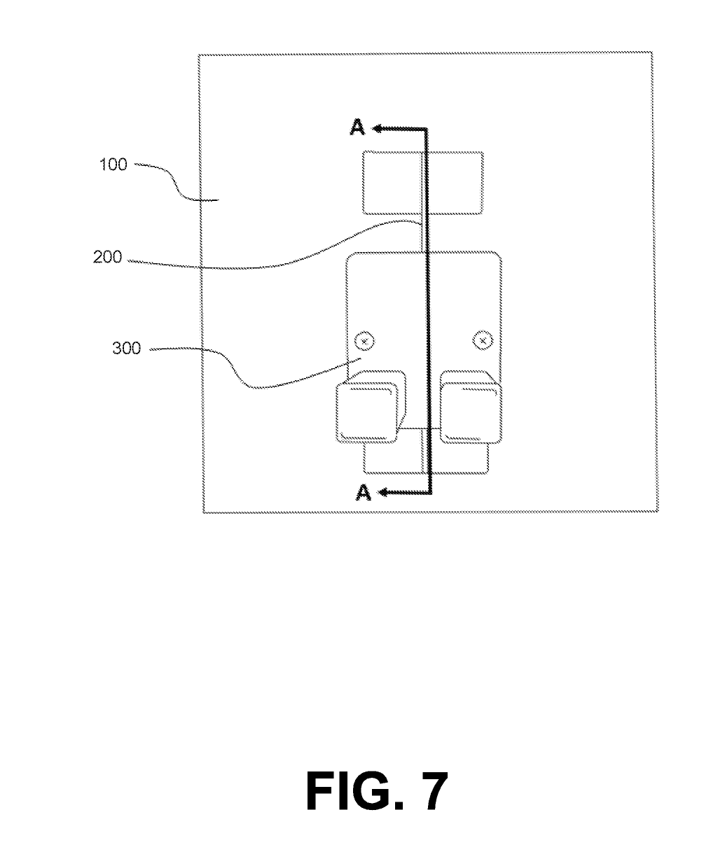

With reference to FIG. 7, shown is an example of a front view of the circuit breaker 100 with the remote actuator assembly 300 installed on the mounting bracket 200. The purpose of FIG. 7 is to identify Section A-A which will be further clarified in FIGS. 8-12.

With reference to FIG. 8, shown is an example of the section view as indicated on FIG. 7 with the remote actuator assembly 300 being installed on the mounting bracket 200. In the view shown, the remote actuator assembly 300 is positioned as it is being installed such that the linear actuator 301 is clearly above the breaker open button 101 while the pins 304 and 305 are engaged to the mounting bracket slots 203 and 204, respectively. FIG. 8 further illustrates that due to dimensional features of the bracket 200 and the actuator assembly 300, the linear actuators 301, 302 of the remote actuator assembly 300 are not in a position that could inadvertently engage the trip and/or close buttons of the circuit breaker.

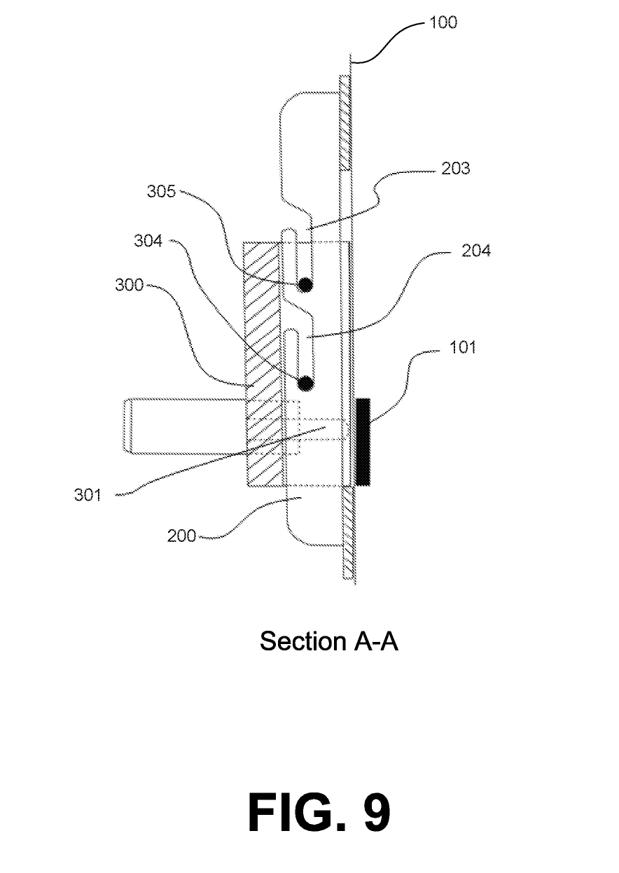

With reference to FIG. 9, shown is an example of the section view as indicated on FIG. 7 with the remote actuator assembly 300 moved downward into the appropriate operating position and engaged with the mounting bracket 200 according to various embodiments of the present disclosure. In this position, the linear actuator 301 is in the fully retracted position and in alignment with the breaker open button 101. The pins 304 and 305 are fully engaged in the mounting bracket slots 203 and 204.

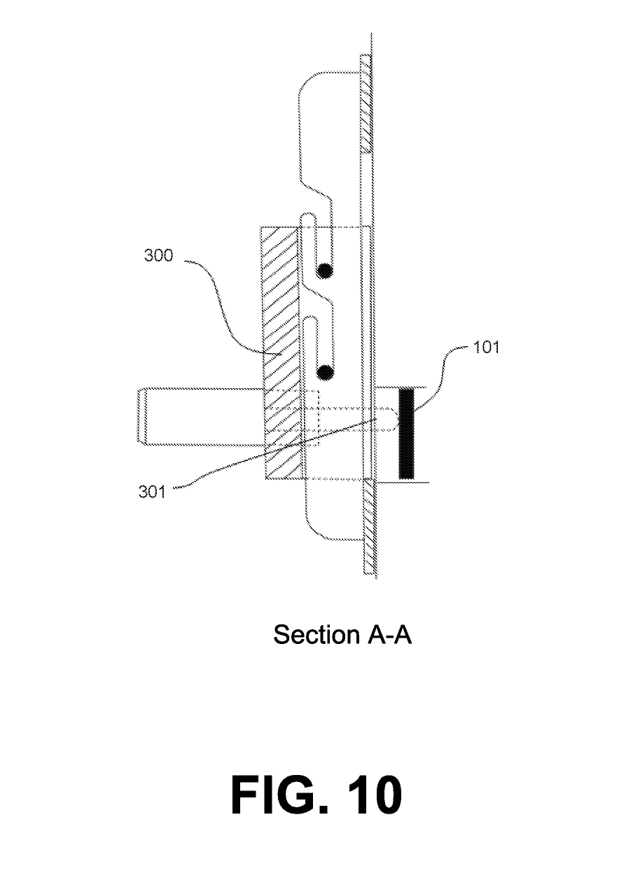

With reference to FIG. 10, shown is an example of the section view as indicated on FIG. 7 with the remote actuator assembly 300 in the appropriate operating position with the linear actuator 301 extended and pressing the breaker close button 101. The example drawings in FIGS. 8-10 illustrate the remote actuator assembly 300 being utilized properly for its intended purpose.

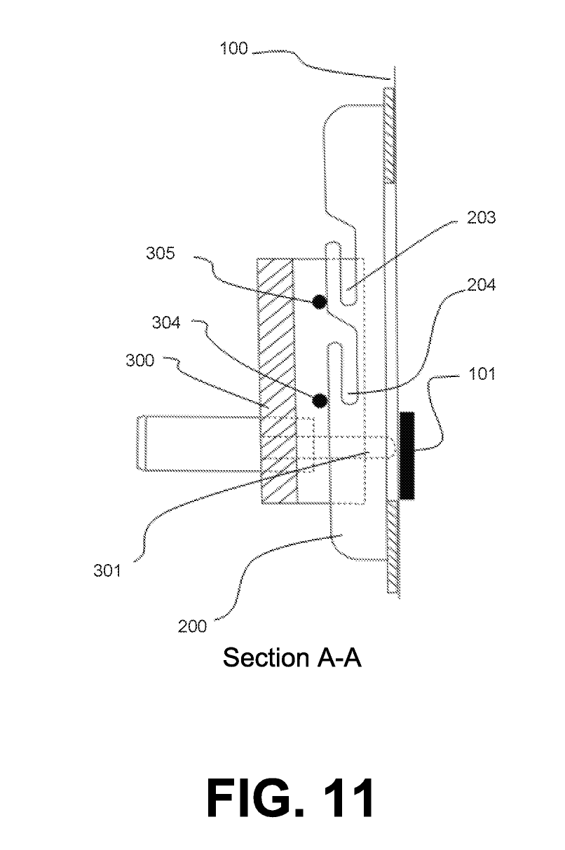

With reference to FIG. 11, shown is an example of the section view as indicated on FIG. 7 with the linear actuator 301 in the extended position and the remote actuator assembly 300 not properly installed on the mounting bracket 200 in accordance to various embodiments of the present disclosure. Specifically, FIG. 11 shows that if the linear actuator(s) 301, 302 of the remote actuator assembly 300 happen to be extended prior to placement on the mounting bracket 200 and a user tries to install the remote actuator assembly 300 onto the mounting bracket 200, the pins 304, 305 will hit the mounting bracket 200 preventing the extended linear actuators from inadvertently engaging with the open button 101 and/or the close button 102 of the circuit breaker 100. Due to the appropriate dimensions of the mounting bracket 200 with respect to the extended linear actuator 301 (e.g., the depth of the slotted section 201 of the mounting bracket 200 being greater than the length of the extended linear actuator 301), the mounting bracket 200 prevents the extended linear actuator 301 from inadvertently engaging with the open button 100.

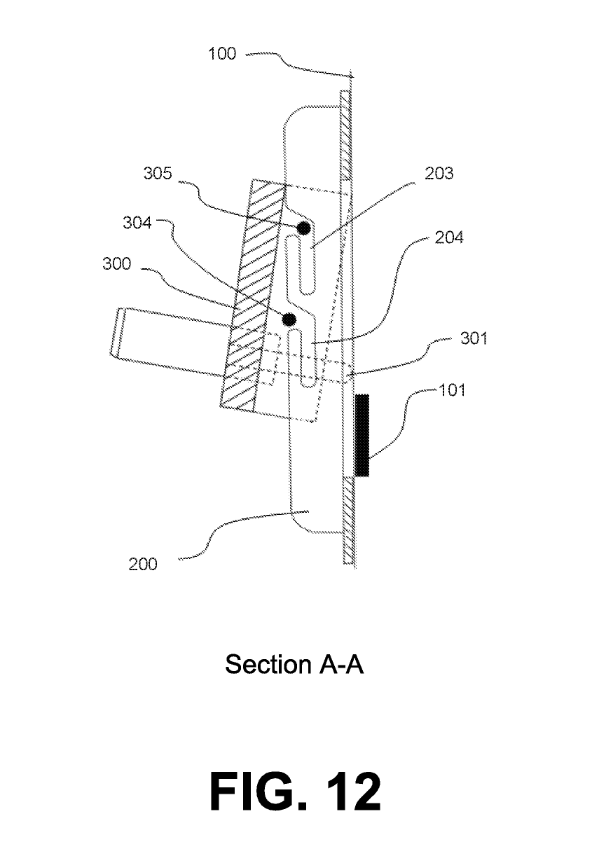

With reference to FIG. 12, shown is an example of the section view as indicated on FIG. 7 with the linear actuator 301 in the extended position and attempting to install the remote actuator assembly 300 with the pins 304 and 305 in alignment with the mounting bracket slots 203 and 204 in accordance to various embodiments of the present disclosure. This illustration shows that if the linear actuator 301 is extended while installing the remote actuator assembly 300 on the mounting bracket 200, the extended linear actuator 301 will contact the face of the breaker above the breaker open button 101. The result is similar to the illustration in FIG. 11, whereas the linear actuator 301, when in the extended position, is unable to inadvertently depress the breaker open button 101 while the actuator is being installed.

FIGS. 8-12 illustrate examples of sectional drawings that only show the linear actuator 301 for the breaker open button 101. The same principles described above in references to these figures would also apply to the breaker close button 101 and the linear actuator 301.

FIGS. 13-17 illustrate examples of drawings of perspective views showing the unique features of the mounting bracket 200 as the typical remote actuator assembly 300 is being installed by a human operator.

With reference to FIG. 13, shown is an example of a perspective view of the remote actuator assembly 300 being installed by a human operator. The typical remote actuator assembly 300 is shown being aligned by the human operator over the mounting bracket 200.

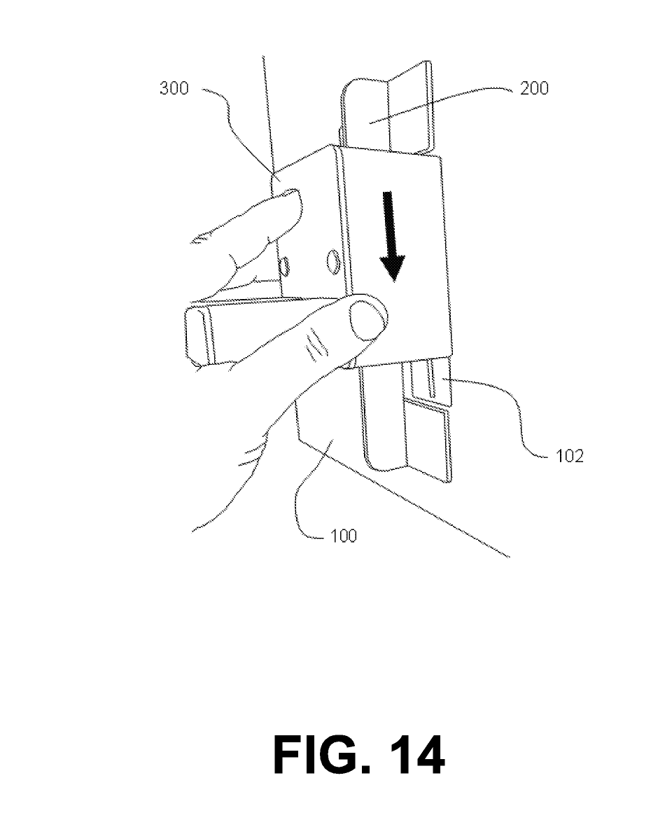

With reference to FIG. 14, shown is an example of a perspective view of the remote actuator assembly 300 being installed by a human operator in accordance to various embodiments of the present disclosure. The remote actuator assembly 300 has been installed over mounting bracket 200, but has not been moved downward into the engaged, or “ready-to-use” operating position. To further clarify, the typical remote actuator assembly 300 is shown in a position that is still above the breaker button 102.

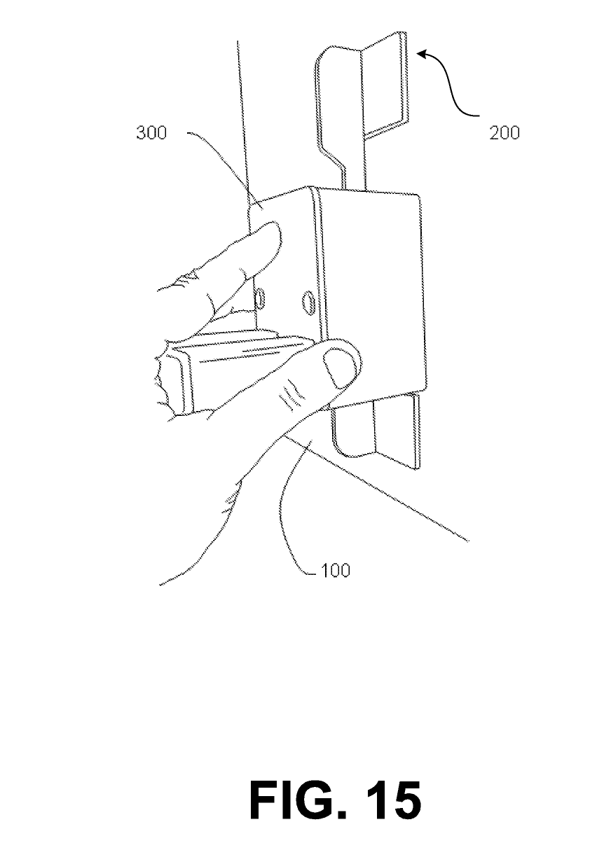

With reference to FIG. 15, shown is an example of a perspective view of the remote actuator assembly 300 being installed by a human operator in accordance to various embodiments of the present disclosure. The typical remote actuator assembly 300 has been moved in a downward direction, while engaged with the mounting bracket 200, to the “ready-to-use” operating position.

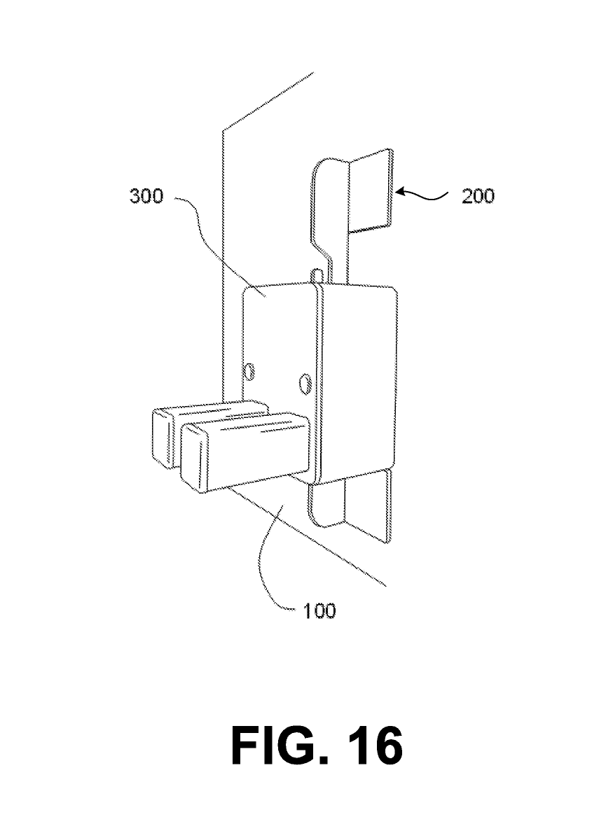

With reference to FIG. 16, shown is an example of a perspective view of a typical remote actuator assembly 300 shown in the “ready-to-use” position in accordance to various embodiments of the present disclosure.

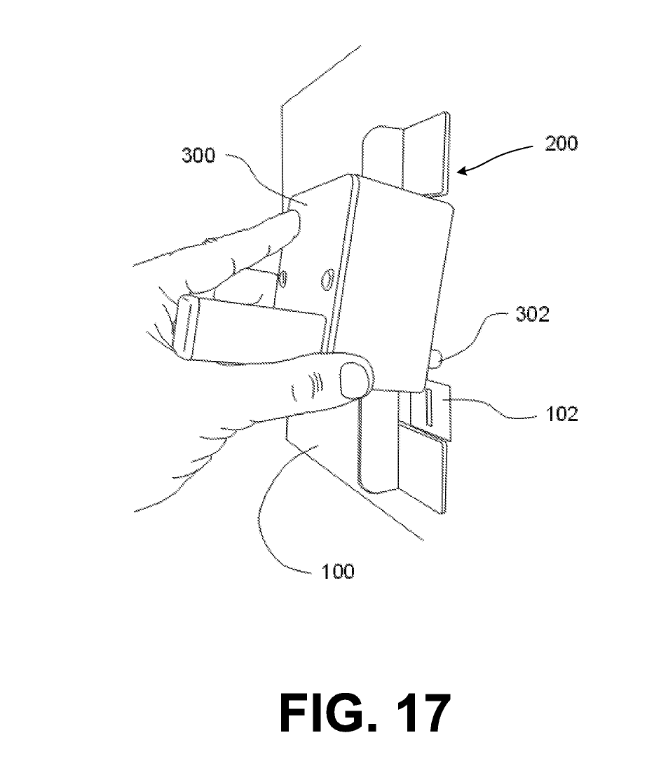

FIG. 17 is an example of a perspective view of the remote actuator assembly 300 being installed by a human operator in which the linear actuator 302 is in the extended position in accordance to various embodiments of the present disclosure. In this example, the extended linear actuator 302 interferes with the face of the breaker which prevents the pins 304 and 305 from engaging with the mounting bracket slots 203 and 204, thereby preventing the human operator from inadvertently pressing the breaker close button 102.

Additionally, it is possible that a mounting bracket 200 could be fabricated and/or mounted onto a circuit breaker 100 with similar features as described in the paragraphs above in which the remote actuator assembly 300 is moved from the left, right, upward, or rotated towards the breaker pushbuttons such that the features would achieve the same protection against an inadvertent operation.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A system for remote operation of a circuit breaker, the system comprising:
a mounting bracket affixed to a face of the circuit breaker, the mounting bracket comprising a slotted section comprising one or more mounting bracket slots; and
a portable actuator assembly coupled to the mounting bracket comprising:
a recessed groove extending from a first end to a second end of the portable actuator, the recessed groove being engaged with the slotted section of the mounting bracket; and
one or more pins positioned substantially perpendicular to the recessed groove, individual pins of the one or more pins being positioned within a respective slot of the one or more mounting slots.

2. The system of claim 1, wherein the portable actuator assembly further comprises an actuator aligned with a breaker button.

3. The system of claim 2, wherein an extension of the actuator actuates the breaker button of the circuit breaker.

4. The system of claim 2, wherein the portable actuator assembly is unable to couple to the mounting bracket when the actuator is extended.

5. The system of claim 1, wherein the mounting bracket is oriented in an approximately vertical position about the circuit breaker.

6. The system of claim 1, wherein the mounting bracket is oriented in an approximately horizontal position about the circuit breaker.

7. The system of claim 1, wherein the mounting bracket further comprises one or more mounting sections, the slotted section extending outwardly and substantially perpendicular to the one or more mounting sections.

8. The system of claim 7, wherein the mounting bracket is attached to the circuit breaker via the one or more mounting sections.

9. The system of claim 8, wherein the one or more mounting sections are attached to the circuit breaker via at least one of an adhesive or a fastening device.

10. The system of claim 1, wherein the one or more mounting bracket slots are sized to engage with the one or more pins.

11. A mounting bracket for attaching a remote actuator assembly to a circuit breaker, the mounting bracket comprising:
a mounting section; and
a slotted section extending outwardly from and substantially perpendicular to the mounting section the slotted section comprising at least one mounting slot sized to engage with at least one pin of the remote actuator assembly.

12. The mounting bracket of claim 11, wherein the slotted section and mounting section are separate and distinct pieces, the slotted section being coupled to the mounting section.

13. The mounting bracket of claim 11, wherein the mounting bracket is a one-piece mounting bracket.

14. The mounting bracket of claim 11, wherein the at least one pin of the remote actuator assembly is unable to engage with the at least one mounting slot when an actuator of the remote actuator is extended.

15. The mounting bracket of claim 11, wherein the slotted section is sized to engage within a recessed vertical groove of the remote actuator.

16. The mounting bracket of claim 11, wherein the mounting section is attached to the circuit breaker.

17. The mounting bracket of claim 11, wherein the mounting section is positioned about the circuit breaker such that when the at least one pin of the remote actuator assembly is fully engaged with the at least one mounting slot, an actuator of the remote actuator assembly is aligned with a breaker button of the circuit breaker.

18. A method, comprising:
attaching a mounting bracket to a face of a circuit breaker;
engaging a pin of an actuator assembly with a slot of the mounting bracket; and
adjusting a position of actuator assembly about the mounting bracket to align an actuator of the actuator assembly with a breaker button of the circuit breaker.

19. The method of claim 18, wherein the actuator assembly is unable to engage with the mounting bracket when the actuator of the actuator assembly is extended during installation thereby preventing engagement of the actuator with the breaker button.

20. The method of claim 18, further comprising positioning the mounting bracket to the face of the circuit breaker such that the pin of the actuator assembly is fully engaged with the slot of the mounting bracket when the actuator is aligned with the breaker button.
